(19) United States
(12) Patent Application Publication
(10) Pub. No.: US 2026/0298279 A1
(43) Pub. Date: Oct. 1, 2026

(54) COMPONENTS, ASSEMBLIES, SYSTEMS, AND METHODS PROVIDING ENHANCED RELIABILITY OF CONNECTIONS BETWEEN COMPONENTS OF HIGH-POWER PUMPS

(71) Applicant: Vulcan Industrial Holdings, LLC, Houston, TX (US)

(72) Inventor: Akhil Alex, Houston, TX (US)

(21) Appl. No.: 19/536,653

(22) Filed: Feb. 11, 2026

Related U.S. Application Data
(60) Provisional application No. 63/779,851, filed on Mar. 28, 2025.

(51) Int. Cl. F16B 33/00; E21B 17/042; F16B 25/00; F16B 33/02; F16B 37/04; F16B 39/30

(52) U.S. Cl. CPC F16B 33/00; E21B 17/042; F16B 25/0047; F16B 33/02; F16B 37/044; F16B 39/30

(57) ABSTRACT

Components, assemblies, systems, and related methods to enhance reliability of a connection between a component and a mating component of the hydraulic fracturing pump, may include a component having a component body including external threads or internal threads, thereby to threadedly engage with mating internal threads or mating external threads, respectively, of the mating component, such that the component and the mating component are connected to one another. The external threads and the mating internal threads, or the internal threads and the mating external threads, may include a rounded thread form, thereby to enhance the reliability of the connection between the component and the mating component of the hydraulic fracturing pump.

### CROSS-REFERENCE TO RELATED APPLICATIONS

This application claims priority to, and the benefit of U.S. Provisional Application No. 63/779,851, filed Mar. 28, 2025, titled “COMPONENTS, ASSEMBLIES, SYSTEMS, AND METHODS PROVIDING ENHANCED RELIABILITY OF CONNECTIONS BETWEEN COMPONENTS OF HIGH-POWER PUMPS,” the disclosure of which is incorporated herein by reference in its entirety.

### TECHNICAL FIELD

The present disclosure relates to components, assemblies, systems, and methods providing enhanced reliability of connections between components of machines and, more particularly, to components, assemblies, systems, and methods providing enhanced reliability of connections between components of high-power pumps.

### BACKGROUND

Machines may be subjected to high loads during operation, including cyclical loads. Cyclical loads may promote component failure due, for example, to fracture initiation and propagation resulting from fatigue. For example, pumps may be used to transfer fluid having a first pressure from one location to another location at a second pressure greater than the first pressure. For example, a reciprocating plunger pump may include a first one-way valve or check-valve to allow fluid to be drawn into the pump and a second one-way valve or check-valve to permit the discharge of the fluid drawn into the pump while the first valve is closed. For example, the first valve may open to allow fluid to be drawn into the pump while the second valve is closed, and thereafter the first valve may close while the second valve is open while a plunger in the pump increases the pressure of the fluid in the pump chamber and forces the fluid through the second valve to pump the fluid.

An example of a high-power pump may be used, for example, to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high flow rates and high pressures may result in significant loading on components associated with the fluid flow, such as the pumps used to pump the fracturing fluid. In many instances, the loads may be cyclic, promoting component failure due, for example, to fracture initiation and propagation resulting from fatigue caused by the cyclic loading. In addition, the fracturing fluid may contain substances, for example, proppants and fluids, having abrasive and corrosive characteristics, and thus, components associated with the fracturing operation may exhibit high wear rates or high failure rates. As a result, components associated with pumps, such as fluid ends, may be particularly susceptible to high wear rates and failures, thereby requiring service or replacement of pump components. For example, it is common to replace components relatively frequently during the service life of a high-power pump, which may result in relatively high maintenance and service inefficiencies over the service life of the high-power pump.

For at least these reasons, Applicant has recognized that it may be desirable to provide components for machines, such as high-power pumps, and related assemblies, systems, and methods, resulting in relatively increased efficiencies associated with the reliability of the components and associated assemblies. At least some examples described herein may address one or more of the above-noted potential issues, as well as possibly others.

### SUMMARY

As referenced above, it may be desirable to provide components of machines, such as high-power pumps, and related assemblies, systems, and methods, resulting in relatively increased efficiencies associated with the reliability of the components, such as, for example, high-power pumps used in the oil and gas industry, where the operating conditions and fluids may present a particularly harsh environment. In some embodiments, the components presented herein may have a relatively enhanced reliability, resulting in less frequent service and replacement of the components. For example, in some embodiments, components that engage one another via a threaded engagement may include rounded thread forms, external or internal, for connecting one component to a mating component having a complimentary rounded thread form, thereby to create a threaded engagement between the two components. In some embodiments, the rounded thread form may provide an enhanced resistance to degradation or failure due to loading, such as cyclic loading, thereby to enhance resistance to fracture initiation and propagation associated with one or more of the two components. In some embodiments, the rounded thread form may provide resistance to galling, other types of thread damage, and/or seizing, which prevents the relative rotation between two threadedly engaged components, for example, during disassembly and separation to the two components from one another. This may provide relatively enhanced reliability, resulting in less frequent service and replacement of the components, which, in turn, may result in numerous efficiencies associated with operation, service, and maintenance associated with the components and related assemblies, systems, and methods.

According to some embodiments, a component for a hydraulic fracturing pump to enhance reliability of a connection between the component and a mating component of the hydraulic fracturing pump, may include a component body having external threads or internal threads, thereby to threadedly engage with mating internal threads or mating external threads, respectively, of the mating component, such that the component and the mating component are connected to one another. The external threads or the internal threads of the component body may include a rounded thread form, thereby to enhance the reliability of the connection between the component and the mating component of the hydraulic fracturing pump.

According to some embodiments, a fluid end assembly for a high-power pump may include fluid end block at least partially defining an exterior surface, a chamber positioned interior relative to the exterior surface, and a bore extending at least partially between the exterior surface and the chamber. The bore may include internal threads having an internal rounded thread form. The fluid end assembly further may include a fluid end component received in the bore, and the fluid end component may include external threads having an external rounded thread form complimentary to the internal rounded thread form of the bore, thereby to enhance the reliability of a connection between the fluid end component and the bore of the fluid end assembly.

According to some embodiments, a high-power pump may include a power end positioned to convert power into reciprocating motion, a plunger connected to the power end and positioned to reciprocate, and a fluid end assembly connected to the power end. The fluid end assembly may include a fluid end block at least partially defining an exterior surface, a chamber positioned interior relative to the exterior surface, and a bore extending at least partially between the exterior surface and the chamber. The bore may include internal threads having an internal rounded thread form. The fluid end assembly further may include a fluid end component received in the bore, and the fluid end component may include external threads having an external rounded thread form complimentary to the internal rounded thread form of the bore, thereby to enhance the reliability of a connection between the fluid end component and the bore of the fluid end assembly.

According to some embodiments, a method for enhancing reliability of a connection between a first fluid end component of a fluid end assembly and a mating fluid end component of the fluid end assembly, may include engaging first threads of the first fluid end component with mating threads of the mating fluid end component. The first threads may have a rounded thread form, and the mating threads may have a rounded thread form complimentary to the rounded thread form of the first threads, thereby to enhance the reliability of the connection between the first fluid end component and the mating fluid end component of the fluid end assembly.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1A is a schematic perspective section view of an example high-power pump including an example fluid end assembly, according to embodiments of the disclosure.

FIG. 1B is a schematic side section view of the example high-power pump shown in FIG. 1A, according to embodiments of the disclosure.

FIG. 2 is a schematic section view of two example components engaged to one another via an example threaded engagement between example complimentary rounded thread forms, according to embodiments of the disclosure.

FIG. 3A is a schematic perspective view of an example packing nut for a high-power pump, according to embodiments of the disclosure.

FIG. 3B is a schematic side section view of the example packing nut shown in FIG. 3A, according to embodiments of the disclosure.

FIG. 4 is a schematic partial perspective section view showing an example suction cover and retainer assembly, according to embodiments of the disclosure.

FIG. 5 is a schematic partial perspective section view showing example fasteners and the example suction cover and retainer assembly shown in FIG. 4, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed to components, assemblies, systems, and related methods that result in enhanced reliability, relatively longer service lives, and reduced downtime associated with use in a machine, such as, for example, a high-power pump, such as pumps used in the oil and gas industry, where the operating conditions and fluids may present a particularly harsh environment. In some embodiments, the components, assemblies, systems, and related methods presented herein may provide connections having a relatively enhanced reliability, which may result in relatively reduced damage and failure rates and relatively increased service lives. For example, in some embodiments, the components may include threads for engagement with complimentary threads of a mating component, and the threads may include a rounded thread form, which may result in increasing the reliability of the components when used, for example, to connect components of a machine, such as a high-power pump to one another, such as, for example, components subjected to high pressure and/or cyclic loading.

For example, machines such as high-power pumps include many components that are connected to one another via threaded engagements. Commonly used thread forms for such engagements include V-shaped thread forms, such as, for example, (a) a form sometimes referred to as a “buttress” thread form or a “sawtooth” thread form, (b) a form according to the United Thread Standard (UTS), such as UNC, UNF, UNEF, and (c) a form sometimes referred to as an ACME thread form. Applicant has recognized that V-shaped thread forms, such as the buttress thread form, the UTS thread form, and the ACME thread form (and similar forms), may each have several drawbacks when used to connect components of a high-power pump. For example, sharp corners between adjacent threads of such thread forms may create stress concentration points that often result in fatigue fractures for components subjected to cyclic loading. Such thread forms also may be adversely affected by debris or dirt infiltrating the engagement between the threads. For example, debris or dirt in the threads may result in threadedly engaged parts becoming galled, damaged, and/or seized to one another.

In some embodiments, components of a machine, such as a high-power pump, may have a rounded thread form to connect adjacent components to one another via a threaded engagement. In some embodiments, for example, a rounded thread form may be characterized by relatively wide rounded crests and rounded roots, avoiding relatively sharp thread profiles, such as V-shaped thread form profiles, that may serve to promote fatigue fractures when subjected to cyclic loading. Applicant has surprisingly found that threaded engagements between components having complimentary rounded thread forms may result in enhanced resistance to fracture, for example, for engaged components subjected to cyclic loading, for example, as compared to components engaged via V-shaped thread forms and similar thread forms. In some embodiments, for example, when engaged components are threadedly engaged via complimentary threads having a rounded thread form, internal and external threads of a rounded thread form may form relatively large spaces between crests and roots of the engaged threads. This may prevent debris between the internal threads and external threads from damaging the threads and/or seizing relative rotation.

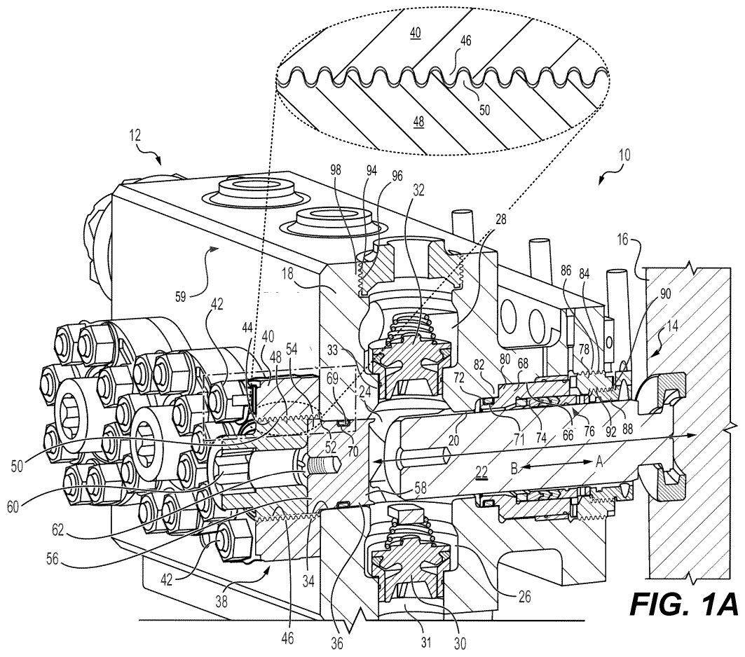

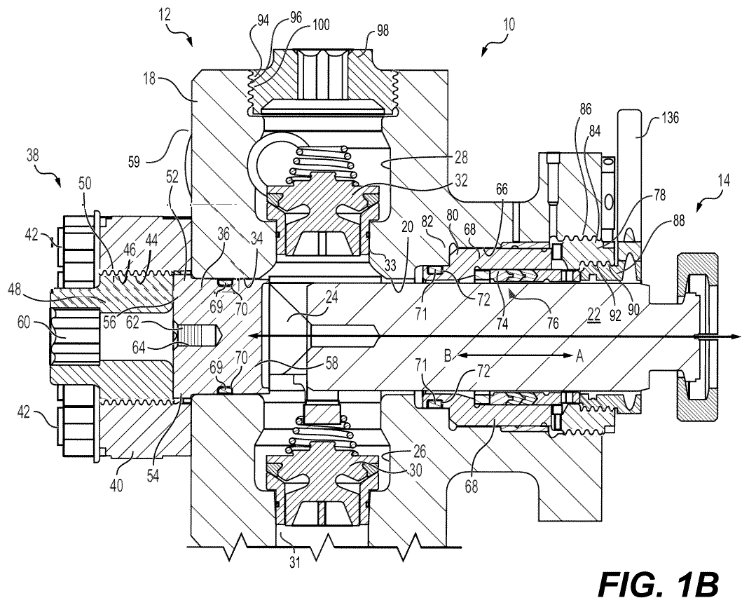

For example, FIG. 1A is a schematic partial perspective section view of an example pump 10, including an example fluid end assembly 12 and an example power end assembly 14 (only schematically depicted), according to embodiments of the disclosure. FIG. 1B is a schematic side section view of the example high-power pump 10 shown in FIG. 1A. The pump 10 may be any high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping hydraulic fracturing fluid. Although embodiments of the pump 10 may be described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof.

For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing pumps, such as reciprocating plunger pumps for pumping fracturing fluid and related methods, other flow control-related and/or pumping-related operations, components, and methods are contemplated.

As shown in FIG. 1A, the example pump 10 may be a reciprocating plunger pump and may include the fluid end assembly 12 and the power end assembly 14 In some embodiments, the power end assembly 14 may include, for example, a housing 16 with mechanical power transmission components, such as a crankshaft, bearings supporting the crankshaft in the housing, crossheads, reduction gears, and/or connecting rods and plungers connected to the connecting rods. In some embodiments, the power end assembly 14 may be configured to convert power into reciprocating motion. For example, the power end assembly 14 may be configured to convert rotational power into reciprocating motion, or the power end assembly 14 may be configured to convert electric or hydraulic power into reciprocating motion.

As shown in FIGS. 1A and 1B, the fluid end assembly 12 may include, for example, a fluid end block 18 including one or more plunger bores 20 in which respective plungers 22 reciprocate, one or more chambers 24 receiving fluid, one or more suction ports 26 for drawing fluid into the one or more chambers 24, and one or more discharge ports 28 for discharging fluid from the one or more chambers 24 at a higher pressure. For example, as each plunger 22, moved via operation of, for example, a crankshaft and a respective connecting rod of the power end assembly 16, at least partially retracts in direction A into a respective cylinder 20, fluid is drawn into the chamber 24 of the fluid end assembly 12 via the suction port 26 in the fluid end block 18 while a suction valve 30 positioned in a suction valve bore 31 is open and a discharge valve 32 positioned in a discharge valve bore 33 is closed. As each plunger 20 returns back toward the chamber 24 in direction B, moved via operation of, for example, the crankshaft and the respective connecting rod of the power end assembly 16, pressurized fluid is discharged from the fluid end assembly 12 via the discharge port 28 in the fluid end block 18 while the discharge valve 32 is open and the suction valve 30 is closed. The suction valve 30 and discharge valve 32 may be one-way valves or check valves, allowing fluid to flow only in a single direction, either into the fluid end block 18 via the suction valve 30, or from the fluid end block 18 via the discharge valve 32. In this example manner, the fluid end assembly 12 draws fluid into the fluid end assembly 12 at a first pressure and discharges the fluid from the fluid end assembly 12 at a higher pressure. In some pump embodiments, the fluid end assembly 12 may include multiple (e.g., two, three, four, or five) sets of suction ports, plunger bores, plungers, and discharge ports to pump fluid at high pressures and/or high flow rates. Other types of pumps, fluid end assemblies, and/or power end assemblies are contemplated.

As shown in FIGS. 1A and 1B, in some embodiments, the fluid end assembly 12 may include an access port 34 providing access to the chamber 24, for example, for use during assembly and/or maintenance of the fluid end assembly 12. The access port 34 may be selectively closed via a suction cover 36 received in the access port 34. In some embodiments, the access port 34 may be defined in the fluid end block 18 by a circular aperture having an interior face having a substantially cylindrical configuration, for example, as shown in FIG. 1A. In some embodiments, the suction cover 36 may have a substantially circular cross-section and may have a substantially cylindrical configuration sized and shaped to fit within the interior face of the access port 34, for example, as shown in FIGS. 1A and 1B. In some embodiments, the suction cover 36 may be sized and shaped to fit snugly within the access port 34.

In some embodiments, a retainer assembly 38 may be used to secure the suction cover 36 within the access port 34. As shown, in some embodiments, the retainer assembly 38 may include an outer housing 40 configured to be secured to an exterior surface of the fluid end block 18 adjacent the access port 34, for example, via one of more fasteners 42, for example, as described herein. The outer housing 40 may define a receiver aperture 44 provided with internal threads 46. The retainer assembly 38 further may include a suction retainer 48, which may include a substantially cylindrical body having external threads 50 configured to threadedly engage the internal threads 46 of the outer housing 40. As described herein, the internal threads 46 and the external threads 50 may be complimentary, facilitating threaded engagement with one another, and may include a rounded thread form. In some embodiments, the suction cover 36 may include a shoulder 52 and a flange 54 having an exterior end 56 opposite an interior end 58 facing the chamber 24. The shoulder 52 and flange 54 may be configured to contact the exterior surface 59 of afront face of the fluid end block 18 adjacent the access port 34. The suction retainer 48 may be threaded into the outer housing 40 and contact the exterior end 56 of the suction cover 36, thereby to secure the suction cover 36 in the access port 34. As shown, in some embodiments, the suction retainer 48 may include a retainer recess 60 configured to be engaged by a tool for assisting the tightening and loosening of the suction retainer 48 relative to the outer housing 40 and the suction cover 36.

As shown in FIGS. 1A and 1B, some embodiments of the suction cover 36 may include a cover recess 62 opening outward from the center of the exterior end 56 of the suction cover 36 surface and having internal threads 64 (FIG. 1B). The cover recess 62 may be used to assist with removal of the suction cover 36, for example, to provide access to the chamber 24. For example, a tool may be used to engage the cover recess 62 (e.g., via the internal threads 64) and assist with pulling the suction cover 36 from the access port 34.

As shown in FIGS. 1A and 1B, in some embodiments, the plunger bore 20 of the fluid end block 18 may include a sleeve recess 66, and a plunger bore sleeve 68 may be received in the sleeve recess 66. The sleeve recess 66 and the plunger bore sleeve 68 may be substantially cylindrical, with the sleeve recess 66 having a substantially circular cross-section and the plunger bore sleeve 68 having a substantially cylindrical outer surface received in the sleeve recess 66. The plunger bore sleeve 68 may be configured to at least partially receive therein the plunger 22 as the plunger 22 reciprocates, thereby to draw fluid into the chamber 24 at a first pressure via the suction port 26 during movement of the plunger 22 in the first direction A, and discharge the fluid from the chamber 24 at a second pressure greater than the first pressure via the discharge port 28 during movement of the plunger 22 in the second direction B, for example, as shown in FIGS. 1A and 1B.

As shown in FIGS. 1A and 1B, an annular seal 69 may be provided between the interior surface of the access port 34 and an exterior surface of the suction cover 36, thereby to provide a fluid seal between the access port 34 the suction cover 36 when the suction cover 36 is received in the access port 34. For example, as shown, the suction cover 36 may include on the outer cylindrical surface thereof an annular groove 70 (FIG. 1B), and the seal 69 may be at least partially received in the annular groove 70.

As shown in FIGS. 1A and 1B, an annular seal 71 may be provided between the interior surface of the sleeve recess 66 and an exterior surface of the plunger bore sleeve 68, thereby to provide a fluid seal between the sleeve recess 66 and the plunger bore sleeve 68 when the plunger bore sleeve 68 is positioned in the sleeve recess 66. For example, as shown, the plunger bore sleeve 68 may include on the outer cylindrical surface thereof an annular groove 72 (FIG. 1B), and the seal 71 may be at least partially received in the annular groove 72.

As shown in FIGS. 1A and 1B, in some embodiments, the plunger bore sleeve 68 may at least partially define a packing recess 74 positioned to received therein a packing assembly 76. For example, the packing recess 74 may define an annular space that receives at least a portion of the packing assembly 76, and the packing assembly 76 may enhance a fluid seal between (a) the fluid end block 18 and/or the plunger bore sleeve 68, and (2) plunger 22 as the plunger 22 reciprocates relative to the fluid end block 18. The packing recess 74 and the packing assembly 76 may be substantially cylindrical, with the packing recess 74 having a substantially circular cross-section and the packing assembly 76 having a substantially cylindrical outer surface received in the packing recess 74. The packing assembly 76 may be configured to at least partially receive therein the plunger 22 as the plunger 22 reciprocates, thereby to draw fluid into the chamber 24 at a first pressure via the suction port 26 during movement of the plunger 22 in the first direction A and discharge the fluid from the chamber 24 at a second pressure greater than the first pressure via the discharge port 28 during movement of the plunger 22 in the second direction B, for example, as shown in FIG. 1. In some embodiments, the packing assembly 76 may include one or more of a junk ring, a header ring, one or more pressure rings, a lube seal, an adaptor ring, or a lantern ring.

As shown, in some embodiments, a sleeve retainer 78 may be positioned to secure the plunger bore sleeve 68 in an axial position relative to the plunger bore 20, for example, such that a shoulder 80 of the plunger bore sleeve 68 contacts and is secured against a corresponding shoulder 82 of the plunger bore 22, for example, as shown in FIGS. 1A and 1B. In some embodiments, the sleeve retainer 78 may include a substantially cylindrical outer surface and a substantially cylindrical inner surface, and the outer surface may be provided with external threads 84 positioned to engage complimentary internal threads 86 of the fluid end block 18 (e.g., of an annular recess of the plunger bore 20), as shown. In some embodiments, the external threads 84 of the sleeve retainer 78 may have a rounded thread form, for example, as described herein, and the internal threads 86 of the fluid end block 18 may have a rounded thread form complimentary to the external threads 84 of the sleeve retainer 78, thereby to provide a threaded engagement between the sleeve retainer 78 and the fluid end block 18. The external threads 84 of the sleeve retainer 78 and the internal threads 86 of the fluid end block 18 may be either right-hand threads or left-hand threads.

In some embodiments, as shown in FIGS. 1A and 1B, the fluid end assembly 12 further may include a packing nut 88 positioned to secure the packing assembly 76 in an axial position relative to the plunger bore 20, for example, such that a first end of the packing assembly 76 contacts and is secured against an end of the packing recess 74 of the plunger bore sleeve 68. In some embodiments, the packing nut 88 may include a substantially cylindrical outer surface and a substantially cylindrical inner surface, and the outer surface of the packing nut 88 may be provided with external threads 90 positioned to engage complimentary internal threads 92 of the sleeve retainer 78, as shown. In some embodiments, the external threads 90 of the packing nut 88 may have a rounded thread form, for example, as described herein, and the internal threads 92 of the sleeve retainer 78 may have a rounded thread form complimentary to the external threads 90 of the packing nut 88, thereby to provide a threaded engagement between the packing nut 88 and the sleeve retainer 78. The external threads 90 of the packing nut 88 and the internal threads 92 of the sleeve retainer 78 may be either right-hand threads or left-hand threads. In some embodiments, the packing nut 88 axially anchors the packing assembly 76 in the annular space in which the plunger 22 reciprocates. In some embodiments, the packing nut 88 may be immediately adjacent (e.g., in contact with) the lantern ring. The packing nut 88 may axially compress the packing assembly 76, for example, in an adjustable manner, depending on the extent to which the packing nut 88 is threaded into the sleeve retainer 78 via the threaded engagement between external threads 90 of the packing nut 88 and the internal threads 92 of the sleeve retainer 78.

As shown in FIGS. 1A and 1B, in some embodiments, the fluid end assembly 12 further may include a discharge access port 94 in the fluid end block 18 positioned to facilitate access to the discharge port 28 and/or the discharge valve 32. The discharge access port 94 may have a substantially cylindrical inner surface including internal threads 96, and the fluid end assembly 12 further may include a discharge cover 98 for selectively closing the discharge access port 94. The discharge cover 98 may have a substantially cylindrical outer surface, including complimentary external threads 100 positioned to engage the internal threads 96 of the discharge access port 94, for example, as shown. In some embodiments, the external threads 100 of the discharge cover 98 may have a rounded thread form, for example, as described herein, and the internal threads 96 of the discharge access port 94 may have a rounded thread form complimentary to the external threads 100 of the discharge cover 98, thereby to provide a threaded engagement between the discharge cover 98 and the discharge access port 94. The external threads 100 of the discharge cover 98 and the internal threads 96 of the discharge access port 94 may be either right-hand threads or left-hand threads.

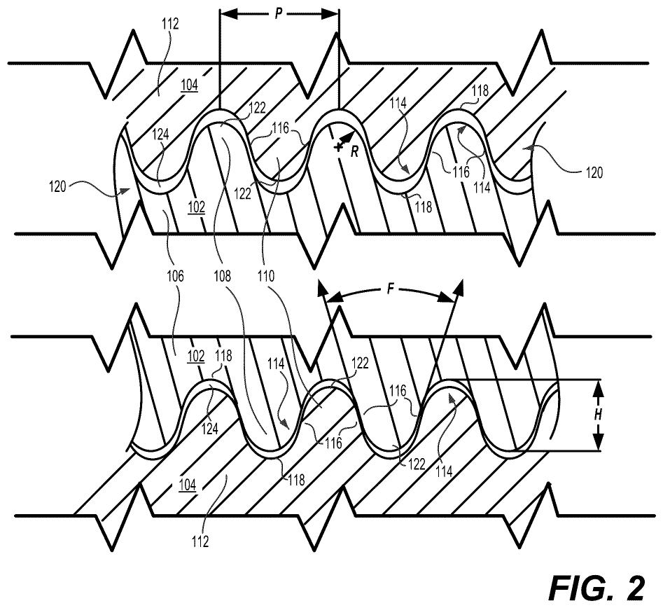

FIG. 2 is a schematic section view of two example components, a first component 102 and the mating component 104, engaged to one another via an example threaded engagement between example complimentary rounded thread forms, according to embodiments of the disclosure. For example, as shown in FIG. 2, the first component 102 may have a component body 106 having a substantially cylindrical outer surface including external threads 108, thereby to threadedly engage with mating internal threads 110 of the mating component 104, such that the first component 102 and the mating component 104 are connected to one another. For example, the mating component 104 may have a component body 112 having a substantially cylindrical inner surface including internal threads 110, thereby to threadedly engage with the external threads 108 of the first component 102, such that the first component 102 and the mating component 104 are connected to one another. It is contemplated that in some embodiments the first component 102 may include external threads, and the mating component 104 may include internal threads. As shown, in some embodiments, the external threads 108 and the internal threads 110 may be complimentary threads engageable with one another, and further, that the external threads 108 and the internal threads 110 may have a rounded thread form, thereby to enhance the reliability of the connection between the first component 102 and the mating component 104, for example, as described herein. The components 102 and 104 may be any components of a machine that are engageable via a threaded engagement, such as, for example, components of a high-power pump, such as those described herein. For example, the first component 102 or the mating component 104 may be a fluid end block, a packing nut, a sleeve retainer, a discharge cover, a suction retainer, or a fastener, such as a nut, a bolt, or a stud, for example, such as those described herein. For example, the components 102 and 104 may be any components that may be subjected to, for example, high loads, cyclic loading, and/or corrosive and/or abrasive materials, such as fluids, solids, semi-solids, slurries, liquids, or combinations thereof, including, for example, materials used in oilfield operations, such as hydraulic fracturing operations.

In some embodiments, the rounded thread form may be one or more of: a fully rounded thread form, a fully radiused root thread form, or a knuckle thread form. For example, the rounded thread form may be a knuckle thread form according to one or more of: (a) the Deutsches Institut für Normung (DIN) standard; or (b) the American Petroleum Institute (API) standard, although other rounded thread forms are contemplated. For example, the rounded thread form may be, for example, consistent with a DIN 20400 thread form, although other rounded thread forms, including non-standard rounded thread forms are contemplated. In some embodiments, the rounded thread form may include any rounded thread form, excluding thread forms according to one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

As shown in in FIG. 2, for example, in some embodiments, the rounded thread form may have a thread profile 114 defining a root radius R, a thread pitch P, a thread height H, and a flank angle F (or thread angle) between adjacent flanks 116 of the thread profile 114. The root radius R describes the radius of the root 118 of the thread profile 114. The thread pitch P describes the distance between adjacent threads 120 of the thread profile 114. The thread height H describes the distance between the root 118 of a thread 120 and the crest 122 of the thread 120.

In some embodiments, the thread profile 114 of the rounded thread form may have a root radius-to-thread height ratio ranging from about 1:1 to about 2:1. For example, the thread profile 114 of the rounded thread form may have a root radius-to-thread height ratio ranging from about 1:1 to about 1.8:1, from about 1:1 to about 1.6:1, from about 1:1 to about 1.4:1, from about 1:1 to about 1.2:1, from about 1.2:1 to about 2:1, from about 1.4:1 to about 2:1, from about 1.6:1 to about 2:1, from about 1.8:1 to about 2:1, from about 1.2:1 to about 1.8:1, or from about 1.4:1 to about 1.6:1. In some embodiments, the thread profile 114 of the rounded thread form may have a root radius-to-thread pitch ratio ranging from about 1:10 to about 1:2. For example, the thread profile 114 of the rounded thread form may have a root radius-to-thread pitch ratio pitch ranging from about 1:10 to about 1:4, from about 1:10 to about 1:6, from about 1:10 to about 1:8, from about 1:8 to about 1:2, from about 1:6 to about 1:2, from about 1:4 to about 1:2, from about 1:8 to about 1:2 (e.g., about 1:4). In some embodiments, the thread profile 114 of the rounded thread form may have a flank angle F ranging from about 20 degrees to about 40 degrees. For example, the thread profile 114 of the rounded thread form may have a flank angle F ranging from about 20 degrees to about 35 degrees, from about 20 degrees to about 30 degrees, from about 20 degrees to about 25 degrees, from about 25 degrees to about 40 degrees, from about 30 degrees to about 40 degrees, from about 35 degrees to about 40 degrees, or from about 25 degrees to about 35 degrees (e.g., about 30 degrees).

Applicant has surprisingly found that, at least in some embodiments, the rounded thread from may enhance a fatigue limit safety factor associated with the first component 102 and/or the mating component 104 by an amount ranging from about 20% to about 60%, as compared to a non-rounded thread form of substantially equivalent size. For example, some embodiments of the rounded thread form may enhance the fatigue limit safety factor by an amount ranging from about 20% to about 50%, from about 20% to about 40%, from about 20% to about 30%, from about 30% to about 60%, from about 40% to about 60%, from about 50% to about 60%, from about 30% to about 50%, from about 35% to about 45%, or from about 45% to about 55% (e.g., about 50%), as compared to a non-rounded thread form of substantially equivalent size. Examples of such non-rounded thread forms include (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; and/or a buttress thread form. Without wishing to be bound by theory, it is believed by Applicant that the rounded thread forms consistent with at least some embodiments described herein may reduce the likelihood or prevent initiation and/or propagation of fractures in the respective roots 118 of the thread profile 114, for example, resulting from high loads and/or fatigue due to cyclic loading.

As shown in FIG. 2, in some embodiments, the thread profile 114 of the rounded thread form may be configured such that the roots 118 of the external threads 108 and the crests 122 of the internal threads 110 (or the roots 118 of the internal threads 110 and the crests 110 of the external threads 110) may define therebetween relatively large respective spaces 124. Without wishing to be bound by theory, it is believed by Applicant that such relatively large spaces 124, in at least some embodiments, may reduce the likelihood or prevent debris that may migrate between the external threads 108 and internal threads 110 from galling, damaging the threads 120, and/or seizing relative rotation between the first component 102 and the mating component 104.

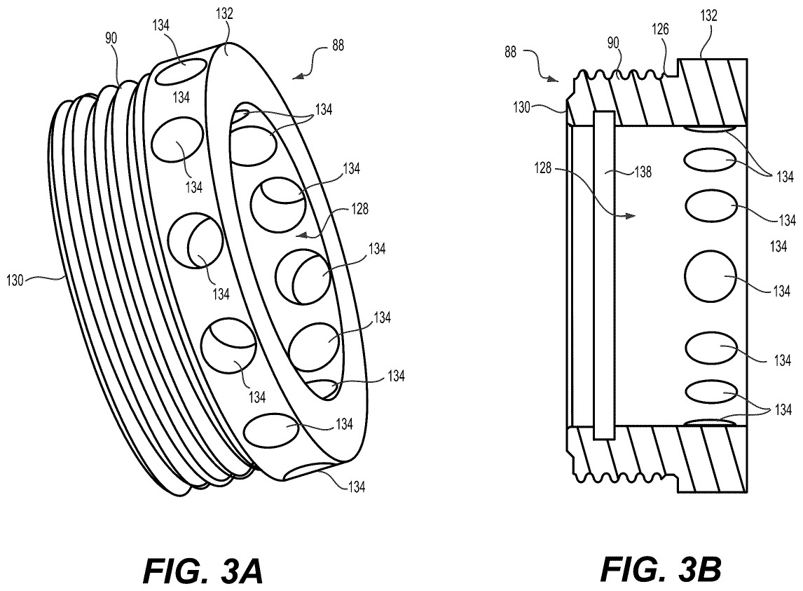

FIG. 3A is a schematic perspective view of an example packing nut 88 for a high-power pump, according to embodiments of the disclosure. FIG. 3B is a schematic side section view of the example packing nut 88 shown in FIG. 3A, according to embodiments of the disclosure. As shown in FIGS. 1A, 1B, 3A, and 3B, the packing nut 88 may be positioned to secure the packing assembly 76 in an axial position relative to the plunger bore 20, for example, such that a first end of the packing assembly 76 contacts and is secured against an end of the packing recess 74 of the plunger bore sleeve 68. The packing nut 88 may include a substantially cylindrical outer surface 126 and a substantially cylindrical inner surface 128, and the outer surface 126 of the packing nut 88 may be provided with external threads 90 positioned to engage complimentary internal threads 92 of the sleeve retainer 78. In some embodiments, the external threads 90 of the packing nut 88 may have a rounded thread form, for example, as described herein, and the internal threads 92 of the sleeve retainer 78 may have a rounded thread form complimentary to the external threads 90 of the packing nut 88, thereby to provide a threaded engagement between the packing nut 88 and the sleeve retainer 78. The external threads 90 of the packing nut 88 and the internal threads 92 of the sleeve retainer 78 may be either right-hand threads or left-hand threads. In some embodiments, the external threads 90 of the packing nut 88 and the internal threads 92 of the sleeve retainer 78 may be a rounded thread form, for example, consistent with a DIN 20400 thread form, although other rounded thread forms, including non-standard rounded thread forms are contemplated.

As shown in FIGS. 3A and 3B, some embodiments of the packing nut 88 may include an annular axial facing contact surface 130 positioned to contact and axially position the packing assembly 76 against the end of the packing recess 74. In some embodiments, the packing nut 88 further may include an annular flange 132 including a plurality of radially extending holes 134 for receipt therein of a packing nut tool 136 (see FIG. 1B) for installing and/or adjusting the packing nut 88 relative to the sleeve retainer 78 and/or packing assembly 76. For example, the packing nut tool 136 may be inserted into one of the holes 134 and may be used to rotate the packing nut 88 to adjust the axial pressure against the packing assembly 76, the contact surface 130 of the packing nut 88 pressing axially against the packing assembly 76. In some embodiments, the packing nut 88 further may define an internal groove 138 facing radially inward and positioned to receive therein a seal for providing a sliding seal between the inner surface 128 of the packing nut 88 and an exterior surface of the plunger 22 as it reciprocates relative to the packing assembly 76 and packing nut 88.

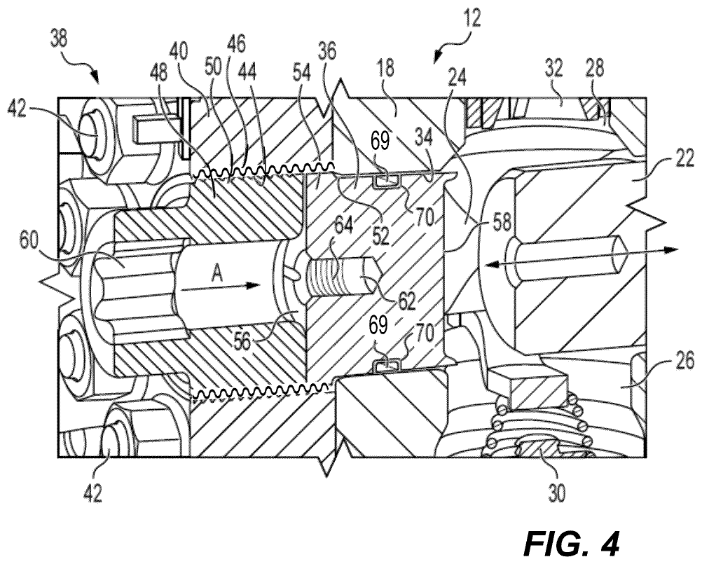

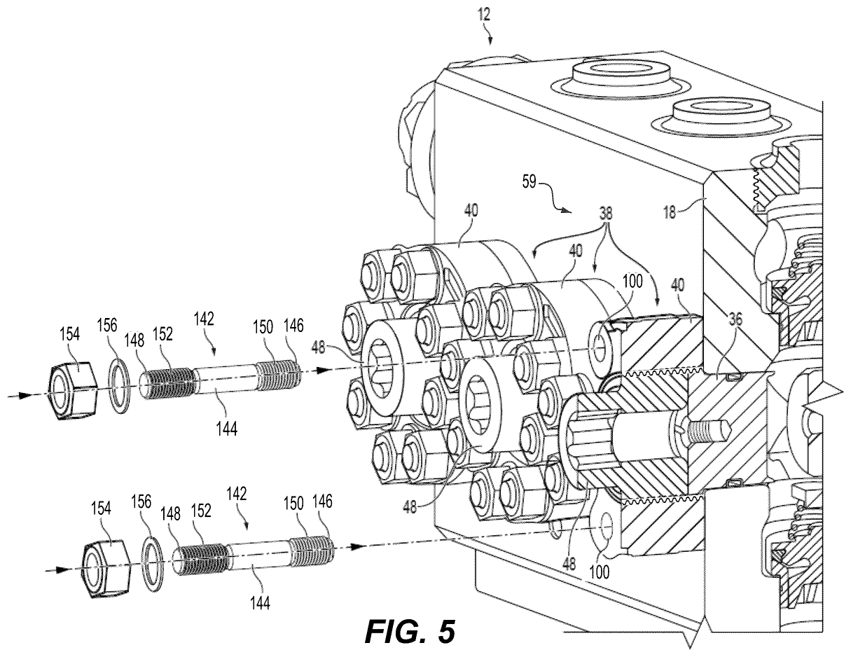

FIG. 4 is a schematic partial perspective section view showing an example suction cover 36 and retainer assembly 38, according to embodiments of the disclosure, and FIG. 5 is a schematic partial perspective section view showing example fasteners 42 and the example suction cover 36 and retainer assembly 38 shown in FIG. 4, according to embodiments of the disclosure. As shown in FIG. 4, in some embodiments, the access port 34 in the fluid end block 18 may provide access to the chamber 24, for example, for use during assembly and/or maintenance of the fluid end assembly 12, as described herein. The access port 34 may be selectively closed via a suction cover 36 received in the access port 34. In some embodiments, the access port 34 may be defined in the fluid end block 18 by a circular aperture having an interior face having a substantially cylindrical configuration, for example, as shown in FIG. 4. In some embodiments, the suction cover 36 may have a substantially circular cross-section and may have a substantially cylindrical configuration sized and shaped to fit within the interior face of the access port 34, for example, as shown in FIG. 4. In some embodiments, the suction cover 36 may be sized and shaped to fit snugly within the access port 34.

In some embodiments, the retainer assembly 38 may be used to secure the suction cover 36 within the access port 34. As shown, in some embodiments, the retainer assembly 38 may include an outer housing 40 configured to be secured to an exterior surface of the fluid end block 18 adjacent the access port 34, for example, via one of more fasteners 42, for example, as described herein. The outer housing 40 may define a receiver aperture 44 provided with internal threads 46. The retainer assembly 38 further may include a suction retainer 48, which may include a substantially cylindrical body having external threads 50 configured to threadedly engage the internal threads 46 of the outer housing 40. As described herein, the internal threads 46 and the external threads 50 may be complimentary, facilitating threaded engagement with one another, and may include a rounded thread form, such as described herein. In some embodiments, the suction cover 36 may include a shoulder 52 and a flange 54 having an exterior end 56 opposite an interior end 58 facing the chamber 24. The shoulder 52 and flange 54 may be configured to contact the exterior surface 59 of afront face of the fluid end block 18 adjacent the access port 34. The suction retainer 48 may be threaded into the outer housing 40 and contact the exterior end 56 of the suction cover 36, thereby to secure the suction cover 36 in the access port 34. As shown, in some embodiments, the suction retainer 48 may include a retainer recess 60 configured to be engaged by a tool for assisting the tightening and loosening of the suction retainer 48 relative to the outer housing 40 and the suction cover 36.

As shown in FIG. 5, the outer housings 40 each may include a plurality of housing holes 140 extending through the respective outer housing 40. In some embodiments, the fasteners 42 may include studs 142, which may extend through each of the housing holes 140 of a respective outer housing 40 and into a respective anchor hole in the exterior surface 59 of the fluid end block 18. It is contemplated that bolts may be used instead of, or in addition to, the studs 142. As shown, the studs 142 may include a stud body 144 extending between an anchor end 146 and an opposite fastener end 148. The anchor end 146 may include external threads 150, which threadedly engage with complimentary internal threads of a respective anchor hole in the fluid end block 18. The fastener end 148 may include external threads 152, which threadedly engage with complimentary internal threads of respective fasteners, such as nuts 154, as shown. For example, in some embodiments, the external threads 150 of the anchor end 146 may have a rounded thread form engaging the internal threads of the respective anchor hole of the fluid end block 18, which may have a complimentary internal rounded thread form, thereby to secure the anchor end 146 of the respective stud 142 in the anchor hole of the fluid end block 18. The external threads 152 of the fastener end 148 may have a rounded thread form and may engage the internal threads of the nuts 154, which may have a rounded thread form complimentary to the rounded thread form of the external threads 152 of the fastener end 148 of the stud 142, thereby to connect the suction cover 36 to the fluid end block 18. In some embodiments, a washer 156 may be provided between each of the nuts 154 and the outer housing 40, for example, as shown in FIG. 5. In some embodiments, the threads of the stud 142, the threads of the anchor holes, and the threads of the nuts 154 having a rounded thread form may enhance the reliability of the connection between a component of a fluid end assembly 12 and a fluid end block 18 of the fluid end assembly 12, for example, as described herein.

Example methods are described below, according to embodiments of the disclosure. The order in which the method steps are described is not intended to be construed as a limitation, and any number of the described method steps may be combined in any order and/or in parallel to implement the methods.

In some embodiments, a method for enhancing reliability of a connection between a first fluid end component 102 of a fluid end assembly 12 and a mating fluid end component 104 of the fluid end assembly 12 may include engaging first threads of the first fluid end component 102 with mating threads of the mating fluid end component 104. The first threads may have a rounded thread form, and the mating threads may have a rounded thread form complimentary to the rounded thread form of the first threads, thereby to enhance the reliability of the connection between the first fluid end component and the mating fluid end component of the fluid end assembly, for example, as described herein. In some embodiments of the method, the engaging of the first threads of the first fluid end component 102 with the mating threads of the mating fluid end component 104 may include enhancing a fatigue limit safety factor associated with the fluid end component 102 and/or the mating fluid end component 104, for example, by an amount ranging from about 20% to about 60%, as compared to a non-rounded thread form of substantially equivalent size, for example, as described herein.

In some embodiments of the method, the mating fluid end component 104 may include a fluid end block 18 defining a bore, and the mating threads may be internal threads 110 associated with the bore. The first threads may be external threads 108 of a cover, and the engaging of the first fluid end component 102 with the mating threads of the mating fluid end component 104 may include engaging the external threads 108 of the cover with the internal threads 110 of the bore. In some embodiments of the method, the mating threads may be internal threads 110 associated with a plunger bore 20, and the first threads may be external threads 108 of a packing nut 88 or a sleeve retainer 78, and the engaging of the first fluid end component 102 with the mating threads of the mating fluid end component 104 may include engaging the external threads 108 of the packing nut 88 or the sleeve retainer 78 with the internal threads of the plunger bore 20, for example, as described herein. In some embodiments of the method, the mating fluid end component 104 may include a valve bore (e.g., suction valve bore 31 and/or discharge valve bore 33), and the mating threads may be internal threads 110 associated with the valve bore. The first threads may be external threads 108 of a discharge cover 98 or a suction retainer 48, and the engaging of the first fluid end component 102 with the mating threads of the mating fluid end component 104 may include engaging the external threads 108 of the the discharge cover or the suction retainer with the internal threads 110 of the valve bore, for example, as described herein. In some embodiments of the method, the mating fluid end component 104 may include a fluid end block 18 defining an anchor hole, and the mating threads may be internal threads 110 associated with the anchor hole. The first threads may be external threads 108 of a bolt or a stud 142, and the engaging of the first fluid end component 102 with the mating threads of the mating fluid end component 104 may include engaging the external threads 108 of the bolt or the stud 142 with the internal threads 110 of the anchor hole.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/779,851, filed Mar. 28, 2025, titled “COMPONENTS, ASSEMBLIES, SYSTEMS, AND METHODS PROVIDING ENHANCED RELIABILITY OF CONNECTIONS BETWEEN COMPONENTS OF HIGH-POWER PUMPS,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A component for a hydraulic fracturing pump to enhance reliability of a connection between the component and a mating component of the hydraulic fracturing pump, the component comprising:
a component body having one of external threads or internal threads, thereby to threadedly engage with one of mating internal threads or mating external threads, respectively, of the mating component, such that the component and the mating component are connected to one another, the one of the external threads or the internal threads of the component body including a rounded thread form, thereby to enhance the reliability of the connection between the component and the mating component of the hydraulic fracturing pump.

2. The component of claim 1, wherein the rounded thread from enhances a fatigue limit safety factor associated with the component by an amount ranging from about 20% to about 60%, as compared to a non-rounded thread form of substantially equivalent size, the non-rounded thread form comprising one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form

3. The component of claim 1, wherein the component comprises one of: a fluid end block, a packing nut, a sleeve retainer, a discharge cover, a suction retainer, a bolt, or a stud.

4. The component of claim 1, wherein the rounded thread form comprises one or more of: a fully rounded thread form, a fully radiused root thread form, or a knuckle thread form.

5. The component of claim 1, wherein the rounded thread form comprises a knuckle thread form according to one or more of: (a) the Deutsches Institut für Normung (DIN) standard; or (b) the American Petroleum Institute (API) standard.

6. The component of claim 1, wherein the rounded thread form excludes thread forms according to one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

7. The component of claim 1, wherein the rounded thread form has a root radius-to-thread height ratio ranging from about 1:1 to about 2:1.

8. The component of claim 1, wherein the rounded thread form has a root radius-to-thread pitch ratio ranging from about 1:10 to about 1:2.

9. The component of claim 1, wherein the rounded thread from enhances a fatigue limit safety factor associated with the component by an amount ranging from about 20% to about 60%, as compared to a non-rounded thread form of substantially equivalent size, the non-rounded thread form comprising one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

10. The component of claim 1, wherein the rounded thread form has a flank, and the flank angle ranges from about 20 degrees to about 40 degrees.

11. The component of claim 1, wherein (a) the one of external threads or internal threads and (b) the one of mating internal threads or mating external threads define spaces for debris therebetween.

12. A fluid end assembly for a high-power pump, the fluid end assembly comprising:
a fluid end block at least partially defining:
an exterior surface;
a chamber positioned interior relative to the exterior surface; and
a bore extending at least partially between the exterior surface and the chamber, the bore including internal threads having an internal rounded thread form; and
a fluid end component received in the bore, the fluid end component including external threads having an external rounded thread form complimentary to the internal rounded thread form of the bore, thereby to enhance the reliability of a connection between the fluid end component and the bore of the fluid end assembly.

13. The fluid end of claim 12, wherein the rounded thread from enhances a fatigue limit safety factor associated with one or more of the fluid end component or the fluid end block by an amount ranging from about 20% to about 60%, as compared to a non-rounded thread form of substantially equivalent size, the non-rounded thread form comprising one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

14. The fluid end of claim 12, wherein the bore comprises an access port, and the fluid end component comprises a cover at least partially received in the access port.

15. The fluid end of claim 12, wherein the bore comprises a plunger bore positioned to at least partially receive therein a plunger, and the fluid end component comprises one of a packing nut or a sleeve retainer, the one of the packing nut or the sleeve retainer at least partially received in the plunger bore.

16. The fluid end of claim 12, wherein the bore comprises a valve bore positioned to receive a valve member, and the fluid end component comprises one of a discharge cover or a suction retainer, the one of the discharge cover or the suction retainer at least partially received in the valve bore.

17. The fluid end of claim 12, wherein the bore comprises an anchor hole, and the fluid end component comprises one of a bolt or a stud, the one of the bolt or the stud received in the anchor hole.

18. The fluid end of claim 12, wherein the rounded thread form comprises one or more of: a fully rounded thread form, a fully radiused root thread form, or a knuckle thread form.

19. The fluid end of claim 12, wherein the rounded thread form comprises a knuckle thread form according to one or more of: (a) the Deutsches Institut für Normung (DIN) standard; or (b) the American Petroleum Institute (API) standard.

20. The fluid end of claim 12, wherein the rounded thread form excludes thread forms according to one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

21. The fluid end of claim 12, wherein the rounded thread form has a root radius-to-thread height ratio ranging from about 1:1 to about 2:1.

22. The fluid end of claim 12, wherein the rounded thread form has a root radius-to-thread pitch ratio ranging from about 1:10 to about 1:2.

23. The fluid end of claim 12, wherein the rounded thread form has a flank, and the flank angle ranges from about 20 degrees to about 40 degrees.

24. The fluid end of claim 12, wherein the external threads and the internal threads define spaces for debris therebetween.

25. A high-power pump comprising:
a power end positioned to convert power into reciprocating motion;
a plunger connected to the power end and positioned to reciprocate; and
a fluid end assembly connected to the power end, the fluid end assembly comprising:
a fluid end block at least partially defining:
an exterior surface;
a chamber positioned interior relative to the exterior surface; and
a bore extending at least partially between the exterior surface and the chamber, the bore including internal threads having an internal rounded thread form; and
a fluid end component received in the bore, the fluid end component including external threads having an external rounded thread form complimentary to the internal rounded thread form of the bore, thereby to enhance the reliability of a connection between the fluid end component and the bore of the fluid end assembly.

26. The high-power pump of claim 25, wherein the rounded thread from enhances a fatigue limit safety factor associated with one of the fluid end component or the fluid end block by an amount ranging from about 20% to about 60%, as compared to a non-rounded thread form of substantially equivalent size, the non-rounded thread form comprising one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

27. The high-power pump of claim 25, wherein the bore comprises an access port, and the fluid end component comprises a cover at least partially received in the access port.

28. The high-power pump of claim 25, wherein the bore comprises a plunger bore positioned to at least partially receive therein a plunger, and the fluid end component comprises one of a packing nut or a sleeve retainer, the one of the packing nut or the sleeve retainer at least partially received in the plunger bore.

29. The high-power pump of claim 25, wherein the bore comprises a valve bore positioned to receive a valve member, and the fluid end component comprises one of a discharge cover or a suction retainer, the one of the discharge cover or the suction retainer at least partially received in the valve bore.

30. The high-power pump of claim 25, wherein the bore comprises an anchor hole, and the fluid end component comprises one of a bolt or a stud, the one of the bolt or the stud received in the anchor hole.

31. The high-power pump of claim 25, wherein the rounded thread form comprises one or more of: a fully rounded thread form, a fully radiused root thread form, or a knuckle thread form.

32. The high-power pump of claim 25, wherein the rounded thread form comprises a knuckle thread form according to one or more of: (a) the Deutsches Institut für Normung (DIN) standard; or (b) the American Petroleum Institute (API) standard.

33. The high-power pump of claim 25, wherein the rounded thread form excludes thread forms according to one or more of: (a) the Unified Thread Standard (UTS) as defined by one or more of the American National Standards Institute (ANSI) or the American Society of Mechanical Engineers (ASME); (b) metric screw threads as defined by the International Organization for Standardization (ISO); (c) the British Standard; (d) a V-thread form; (e) an ACME thread form; (f) a square thread form; (g) a Whitworth thread form; or a buttress thread form.

34. The high-power pump of claim 25, wherein the rounded thread form has a root radius-to-thread height ratio ranging from about 1:1 to about 2:1.

35. The high-power pump of claim 25, wherein the rounded thread form has a root radius-to-thread pitch ratio ranging from about 1:10 to about 1:2.

36. The high-power pump of claim 25, wherein the rounded thread form has a flank, and the flank angle ranges from about 20 degrees to about 40 degrees.

37. The high-power pump of claim 25, wherein the external threads and the internal threads define spaces for debris therebetween.

38. A method for enhancing reliability of a connection between a first fluid end component of a fluid end assembly and a mating fluid end component of the fluid end assembly, the method comprising:
engaging first threads of the first fluid end component with mating threads of the mating fluid end component, the first threads having a rounded thread form, and the mating threads having a rounded thread form complimentary to the rounded thread form of the first threads, thereby to enhance the reliability of the connection between the first fluid end component and the mating fluid end component of the fluid end assembly.

39. The method of claim 38, wherein the engaging of the first threads of the first fluid end component with the mating threads of the mating fluid end component comprises enhancing a fatigue limit safety factor associated with one or more of the fluid end component or the mating fluid end component by an amount ranging from about 20% to about 60%, as compared to a non-rounded thread form of substantially equivalent size.

40. The method of claim 38, wherein:
the mating fluid end component comprises a fluid end block defining a bore,
the mating threads are internal threads associated with the bore,
the first threads are external threads of a cover, and
the engaging of the first fluid end component with the mating threads of the mating fluid end component comprises engaging the external threads of the cover with the internal threads of the bore.

41. The method of claim 38, wherein:
the mating fluid end component comprises a fluid end block defining a plunger bore,
the mating threads are internal threads associated with the plunger bore,
the first threads are external threads of one of a packing nut or a sleeve retainer, and
the engaging of the first fluid end component with the mating threads of the mating fluid end component comprises engaging the external threads of the one of the packing nut or the sleeve retainer with the internal threads of the plunger bore.

42. The method of claim 38, wherein:
the mating fluid end component comprises a fluid end block defining a valve bore,
the mating threads are internal threads associated with the valve bore,
the first threads are external threads of one of a discharge cover or a suction retainer, and
the engaging of the first fluid end component with the mating threads of the mating fluid end component comprises engaging the external threads of the one of the discharge cover or the suction retainer with the internal threads of the valve bore.

43. The method of claim 38, wherein:
the mating fluid end component comprises a fluid end block defining an anchor hole,
the mating threads are internal threads associated with the anchor hole,
the first threads are external threads of one of a bolt or a stud, and
the engaging of the first fluid end component with the mating threads of the mating fluid end component comprises engaging the external threads of the one of the bolt or the stud with the internal threads of the anchor hole.
